(19) United States
(12) Patent Application Publication
(10) Pub. No.: US 2026/0257520 A1
(43) Pub. Date: Sep. 3, 2026

(54) SENSOR DEVICE COMPRISING A FIRST COMMUNICATION INTERFACE FOR CONNECTION TO A SECOND WIRELESS COMMUNICATION INTERFACE ON A MOVABLE OBJECT

(71) Applicant: Robert Bosch GmbH, Stuttgart (DE)

(72) Inventors: Sergej Till, Heilbronn (DE); Michael Blessenohl, Reutlingen (DE); Yann Ravier, Tuebingen (DE)

(21) Appl. No.: 18/994,648

(22) PCT Filed: Jul. 11, 2023
(86) PCT No.: PCT/EP2023/069095

§ 371 Date: Jan. 15, 2025

(30) Foreign Application Priority Data
Jul. 18, 2022 (DE) 10 2022 207 317.7

(51) Int. Cl. B60C 23/04; H04L 1/00; H04Q 9/00; H04W 28/04

(52) U.S. Cl. CPC B60C 23/0462; B60C 23/0471; H04L 1/0002; H04Q 9/00; H04W 28/04

(57) ABSTRACT

A sensor device. The sensor device includes a first wireless communication interface for connection to a second wireless communication interface on a movable object, in particular a vehicle. The sensor device performs: operating the sensor device in a first state in which only non-sensitive data can be transmitted to the second wireless communication interface; sending a connection signal to the second wireless communication interface when the sensor device is operated in a first state and is moved at a predetermined speed and/or a predetermined rotation rate; establishing a secure connection to the moving object using the second wireless communication interface; transmitting sensitive data using the secure connection, and storing the sensitive data; transferring the sensor device to a second state in which only non-sensitive data can be transmitted; changing the state of the sensor device to the first state when a predefinable reset event occurs.

### FIELD

The present invention relates to a sensor device comprising a first wireless communication interface for connection to a second wireless communication interface on a movable object, in particular a vehicle.

The present invention further relates to a movable object, in particular a vehicle, comprising a second wireless communication interface for establishing a connection to a first wireless communication interface.

The present invention further relates to a system including a sensor device and a moving object, in particular a vehicle.

Although generally applicable to movable objects, the present invention is explained using a motor vehicle.

### BACKGROUND INFORMATION

For checking the air pressure in vehicle tires, it has become conventional to measure the air pressure by means of a sensor in the tire and to transmit the measured values wirelessly to the vehicle.

The sensors are usually designed as sending units without a direct bidirectional communication option. This means that the sensors can transmit data but cannot receive data from the vehicle, or a third device is required to establish the connection.

When changing tires or replacing a sensor, the newly installed sensor must then be manually connected to the vehicle so that the sensor is reconnected to the vehicle and the vehicle can receive data again.

### SUMMARY

In one example embodiment, the present invention provides a sensor device comprising a first wireless communication interface for connection to a second wireless communication interface on a movable object, in particular a vehicle, wherein the sensor device is designed to perform the following steps:
operating the sensor device in a first state in which only non-sensitive data can be transmitted to the second wireless communication interface;
sending a connection signal to the second wireless communication interface when the sensor device is operated in a first state and is moved at a predetermined speed and/or a predetermined rotation rate;
establishing a secure connection to the moving object using the second wireless communication interface;
transmitting sensitive data such as connection data, in particular connection keys and parameter data, by means of the secure connection, and storing the sensitive data;
transferring the sensor device to a second state in which only non-sensitive data can be transmitted;
changing the state of the sensor device to the first state and deleting at least some of the stored sensitive data when a predefinable reset event occurs.

In one example embodiment, the present invention provides a movable object, in particular a vehicle, comprising a second wireless communication interface for establishing a connection to a first wireless communication interface, in particular a wireless communication interface of a sensor device, wherein the movable object is designed to perform the following steps:
operating the movable object in a first state in which only non-sensitive data can be transmitted to the first wireless communication interface;
receiving a connection signal from the first wireless communication interface;
establishing a secure connection to the sensor device using the first wireless communication interface;
transmitting sensitive data such as connection data, in particular connection keys and parameter data, by means of the secure connection, and storing the sensitive data;
transferring the movable object to a second state in which only non-sensitive data can be transmitted;
changing the state of the movable object to the first state and deleting at least some of the stored sensitive data when a predefinable reset event occurs.

In one example embodiment, the present invention provides a system including a sensor device according to the present invention and a moving object, in particular a vehicle.

One of the advantages achieved is that the sensor device can only connect to the object for configuration during movement, for example when a vehicle is moving. This reduces the risk that the sensor device accidentally connects to the wrong object and thus becomes incorrectly configured, or that an attacker can connect to the sensor device unnoticed in order to access data without authorization. A further advantage is that when the sensor is removed from the moving object, for example when changing a tire, a reset event automatically takes place, so that the sensor device deletes the connection data and switches to an unconfigured state—i.e., the first state and the sensor device can reconnect to a vehicle for configuration. In addition, sensitive data, such as a vehicle number, can also be exchanged between the sensor device and the movable object, since the risk that the data will be used without authorization is minimized.

Non-sensitive data within the meaning of the present invention are in particular data that are not protected against unauthorized access. For example, they include diagnostic data from a tire such as air pressure, tire type or error messages. Sensitive data are data that are protected from unauthorized access, since they allow conclusions to be drawn about the owner of a vehicle, for example. In particular, they comprise a vehicle serial number, parameter data or the like, and in particular commands for changing the technical functionality of the sensor, for example for changing a measurement and/or sending interval—i.e., the number of measurements per time interval. Parameter data can be used for setting the sensor device in relation to the object and vice versa.

In the first state of the sensor device, only non-sensitive data are transmitted. In particular, the first state is an unconfigured state. The sensor device can thus be used as a pure sending device, since the identity of devices receiving the data does not need to be checked. As soon as the sensor device detects that it is being moved, for example because the object is moving, it can establish an encrypted connection to the object. Since the object is moving, it is unlikely that a connection request from the sensor device can be accepted by a communication interface other than that of the moving object. This means that sensitive data can also be transmitted, since the identity of the data recipient is known. In this manner, the connection between the sensor device and the moving object can be established automatically without the need for manual intervention. Once the secure connection has been established, parameter data can be transmitted via said connection so that, for example, the sensor device can configure itself in relation to the object. These data are stored so that the sensor device retains the configuration until the sensor device is reset. The sensor device subsequently switches to the second state, in which non-sensitive data are transmitted again. In particular, the second state is a configured state of the sensor device.

Once a reset event occurs, for example because a tire is removed from a vehicle, the sensor device automatically changes to the first state, in which the sensor device is not configured. As soon as a sensor device is located on a moving object again, the sensor device can automatically re-establish the connection to the object in order to reconfigure itself in relation to the object. In this manner, the sensor device can also be connected to any moving object and automatically reset when it is no longer located on a known object.

According to an advantageous further development of the present invention, the predefinable reset event comprises a faulty and/or inadequate response of the second wireless communication interface to a connection signal of the first wireless communication interface, a lack of confirmation of receipt of the second wireless communication interface, an actuation event of an actuation element on the sensor device and/or the object, a predetermined sequence of sensor signals of the sensor device, a predetermined sequence of speed and/or rotation rate values of the sensor, a signal of a third wireless communication interface, a reset message of the second wireless communication interface and/or a lapse of a predetermined time since a change to the second state. There are various events that may require a reset to the first state. For example, the sensor device can send a request to check whether the connection still exists. If the vehicle does not respond, responds with an incorrect key, or responds with an unknown sender address, the sensor device is no longer located on the correct vehicle and can be reset to its original state. The sensor device can also be reset to the first state if implausible sensor signals indicate that the sensor device is not located on the expected vehicle. Furthermore, the connection can also be reset to the first state manually, for example by pressing a button or a radio signal, for example if a workshop has serviced the vehicle. The advantage of this is that the second state does not remain active beyond the desired period of use.

According to an advantageous further development of the present invention, all sensitive data are deleted when a reset event occurs. For establishing the secure connection, keys and parameters can be exchanged between the moving object and the sensor device, which make the configuration of the sensor device possible. These can be deleted when the reset event occurs in order to prevent incorrect parameters from being used for the sensor device.

According to an advantageous further development of the present invention, the sensor device comprises an air pressure sensor, in particular an air pressure sensor for measuring a tire pressure. The method can be used in particular to connect sensors in vehicle tires to the vehicle. The advantage of this is that the connection between an air pressure sensor in the tire and the vehicle can be established in a simple manner.

According to an advantageous further development of the present invention, the sensor device comprises an acceleration sensor, speed sensor and/or rotation rate sensor. The sensor device only sends a connection request when the object is moving. In addition, the connection request can only be sent when the sensor device is in the first state in order to save energy. In order to detect a movement of the sensor, it is advantageous when the sensor device can ascertain this movement via a sensor. The sensor can in particular be a rotation rate sensor when the sensor is located in a tire. The sensor device can thus comprise a plurality of sensors, wherein not all measured values are transmitted to the moving object. The sensor can also be an accelerometer that measures a radial acceleration and/or a centripetal acceleration, from which the speed of the sensor can be inferred.

According to an advantageous further development of the present invention, the sending of a connection signal is only performed when the acceleration sensor measures a centripetal force greater than 1.6 g, preferably 6.4 g, in particular 14.4 g, when the rotation rate sensor measures a minimum rotation rate greater than 500°/s, in particular greater than 1000°/s, preferably greater than 1500°/s and/or when the speed sensor measures a minimum speed greater than 10 km/h, in particular greater than 20 km/h, preferably greater than 30 km/h. The advantage of this is that it can be ensured that the moving object has a sufficiently high speed, so that accidental connection to another object is unlikely.

According to an advantageous further development of the present invention, the sending of a connection signal is only performed when the minimum rotation rate and/or the minimum speed is measured for at least 30 seconds, preferably 45 seconds, in particular 90 seconds. The time can depend on the speed, for example 90 seconds at 10 km/h, 45 seconds at 20 km/h and 30 seconds at 30 km/h. As a result, it is ensured that the object has traveled a sufficiently large distance, so that a potential attacker who wants to access data without authorization is no longer within range of the sensor device. To increase safety, it is possible to keep the test period significantly longer, for example 10 to 15 minutes, in particular if other parameters are checked in addition to speed. The time can also be calculated cumulatively, so that a short stop, for example at a traffic light, only pauses the process and does not completely end it. It is also possible that the sensor device estimates the distance traveled and makes the connection request based on this.

According to an advantageous further development of the present invention, the first and/or the second wireless communication interface comprises a Bluetooth interface, in particular a Bluetooth Low Energy interface. As a result, the connection between the sensor device and the object can be established in a particularly simple and energy-efficient manner. Other wireless interfaces such as WLAN or the like are also possible.

According to an advantageous further development of the present invention, the sending of a connection signal is based on an instantaneous angular velocity, a wheel position, a certain object speed and/or acceleration, a direction of rotation of a wheel, object vibrations, a signal strength, signal direction and/or signal polarization. Additional data to be used for validation can be measured by the sensor device and the object. If both the object and the sensor measure approximately similar values, the sensor device can make a connection request. It is also possible that the signal is checked for plausibility based on the strength, direction and/or polarization of the signal and is thus used for validation.

Further important features and advantages of the present invention can be found in the disclosure herein.

It is self-evident that the features mentioned above and those still to be explained below can be used not only in the combination specified in each case, but also in other combinations or alone, without departing from the scope of the present invention.

Preferred designs and example embodiments of the present invention are illustrated in the figures and explained in more detail in the following description.

### BRIEF DESCRIPTION OF THE DRAWINGS

FIG. 1 shows a sensor device according to one example embodiment of the present invention.

FIG. 2 shows an object according to one example embodiment of the present invention.

FIG. 3 shows a system according to one example embodiment of the present invention.

### DETAILED DESCRIPTION OF EXAMPLE EMBODIMENTS

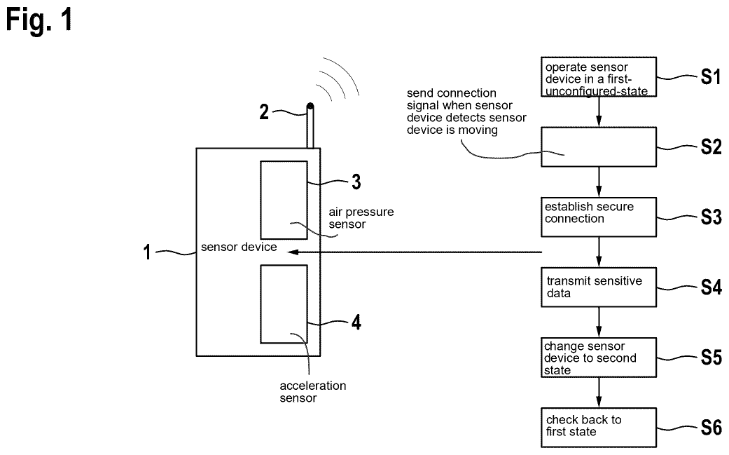

FIG. 1 shows a sensor device according to one embodiment of the present invention.

The sensor device 1 comprises a first wireless communication interface 2, with which the sensor device 1 can be connected to an object (not shown). The sensor device 1 is designed to perform the following steps:

In a first step S1, the sensor device 1 is operated in a first-unconfigured-state, in which non-sensitive data can be transmitted to a second wireless communication interface (not shown). The sensor device 1 comprises an air pressure sensor 3 with which the air pressure in a tire (not shown) can be measured. As long as the sensor device 1 is not connected to a suitable receiver, for example a vehicle, the sensor device 1 is operated in a first state with limited functionality. In this first state, the sensor device 1 only sends non-sensitive data such as diagnostic data, air pressure or error messages, but is not configured. These data can also be read out by a workshop, for example, for servicing purposes.

The sensor device 1 further comprises an acceleration sensor 4, with which it can be detected whether the sensor device 1 is moving. If a radial acceleration is measured, this may imply, for example, that a vehicle on which the sensor device 1 is located is moving, for example the vehicle is being driven by a user. It is likewise possible that the sensor device 1 does not have a sensor for recognizing a movement and receives information about a possible movement of the vehicle and thus of the sensor device 1 from an external device.

As soon as the sensor device 1 detects that the sensor device 1 is moving, in a second step S2 a connection signal is sent to a second wireless communication interface (not shown) of an object. Since the connection signal is only sent when the sensor device 1 is moving and in the first state, it can be ensured that only the desired object can connect to the sensor device 1. Subsequently, the desired object can accept the connection.

Thus, in a third step S3, a secure connection to the object is established using the second wireless communication interface. As a result, the sensor device 1 and the object can exchange sensitive data. Since the object is moving, there is little risk that this sensitive data will be transmitted to third parties

In a fourth step S4, sensitive data such as connection data, for example connection keys and parameter data, are transmitted and stored by means of the secure connection, for example by the sensor device 1. In addition, the sensor device can be configured based on the sensitive data, so that, for example, a sending interval for the air pressure is set.

Since the sensor device 1 is now configured, the sensor device 1 changes to a second state (step S5) in which only non-sensitive data are again transmitted by means of the first wireless communication interface 2. Since the sensor device 1 is configured, it again sends non-sensitive data such as air pressure. Due to the configuration, the sensor device 1 can send the data in response to requests from the object, for example in relation to the sending interval or the sending frequency for the air pressure.

Both the object and the sensor device 1 have exchanged connection data in order to configure themselves and are thus in the second state. However, this second state should not be permanently active. For example, the sensor device 1 could be located in a tire on the object, so that when the tire is changed, the second state must be aborted again. For this purpose, the sensor device 1 can regularly send a signal by means of the first communication interface 2 and, for example, query the connection key. As long as the sensor device 1 is in the vicinity of the object, the object can send a response to the signal by means of the second communication interface. When the sensor device 1 is removed from the object, the sensor device 1 does not receive a response to the signal, or does not receive the expected response when it is located on another object. Thus, a reset event has occurred.

In this case, the state of the sensor device 1 is changed back to the first state in a sixth step S6, so that the sensor device is again operated in the unconfigured first state. For this purpose, the sensitive data, in particular the connection keys and parameters, are deleted so that the sensor device 1 can reconnect to an object. Other possible reset events in which the second state is reset could be, for example, a manual triggering of a button or a radio signal. For example, a workshop employee could force a connection reset after servicing a vehicle.

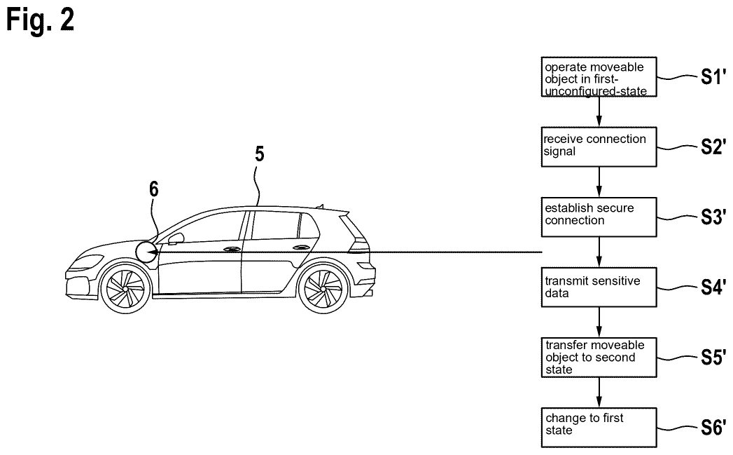

FIG. 2 shows an object according to one embodiment of the present invention.

FIG. 2 shows a movable object 5, here in the form of a vehicle, comprising a second wireless communication interface 6. By means of the second wireless communication interface, the vehicle 5 can be connected to a sensor device (not shown), in particular to a first wireless communication interface of a sensor device, for example a sensor device according to FIG. 1. The movable object 5 is designed to carry out the following steps:

In a first step S1′, the movable object 5 is operated in a first-unconfigured-state, in which only non-sensitive data can be transmitted to the first wireless communication interface (not shown).

In a second step S2′, a connection signal from the first wireless communication interface is received. In particular, connection signals are received by the first wireless communication interface when the sensor device of the first wireless communication interface is in motion.

In a third step S3′, a secure connection is established with the sensor device using the first wireless communication interface.

In a fourth step S4′, sensitive data such as connection data, for example connection keys and parameter data, are transmitted by means of the secure connection and stored by the movable object.

In a fifth step S5′, the movable object 5 is transferred to a second state in which only non-sensitive data can be transmitted. In a sixth step S6′, the state of the movable object 5 is changed to the first state and the stored sensitive data are deleted when a predefinable reset event occurs.

The steps S1′ to S6′ mentioned substantially correspond to the steps S1 to S6 according to FIG. 1, with the roles of the first and second communication interface 6 swapped.

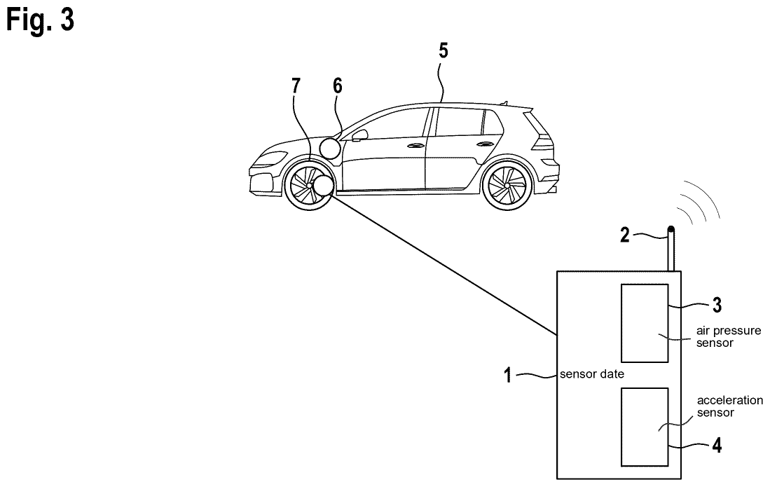

FIG. 3 shows a system according to one embodiment of the present invention.

FIG. 3 shows a system including an object 5, here in the form of a vehicle, and a sensor device 1. By means of the first communication unit 2 and the second communication unit 6, the sensor device 1 and the vehicle 5 can communicate with one another. The sensor device 1 is located on a wheel 7 of the vehicle 5. Using an air pressure sensor 3, the sensor device 1 measures the air pressure of the tire 7 and transmits it to the vehicle 5. To establish a connection between the vehicle 5 and the sensor device 1, the vehicle 5 is set in motion. The sensor device 1 detects this via the acceleration sensor 4 and sends a connection request. Since vehicle 5 is moving, it is highly likely that only vehicle 5 will accept this connection request. Configuration parameters can then be exchanged via the secure connection. This configuration of the vehicle 5 and the sensor device 1 is maintained until a reset event occurs. For establishing the connection, the sensor device 1 consequently performs the steps S1 to S6 and the vehicle 5 performs the steps S1′ to S6′. As a result, the connection is automatically established.

In summary, at least one embodiment of the present invention has at least one of the following features and/or provides at least one of the following advantages:
Secure connection of sensor and object
Automated connection of sensor and object
Low risk that data will be sent to third parties
Low risk of unintentional configuration of the sensor unit by third parties

Although the present invention has been described with reference to preferred exemplary embodiments, it is not limited thereto, but can be modified in many ways.

1-11. (canceled)

12. A sensor device, comprising:
a first wireless communication interface for connection to a second wireless communication interface on a movable object, the moveable object being a vehicle, wherein the sensor device is configured to:
operate the sensor device in a first state in which only non-sensitive data can be transmitted to the second wireless communication interface,
send a connection signal to the second wireless communication interface when the sensor device s operated in a first state and is moved: at a predetermined speed and/or a predetermined rotation rate,
establish a secure connection to the moving object using the second wireless communication interface,
transmit sensitive data such as connection data, including connection keys and parameter data, using the secure connection, and store the sensitive data,
transfer the sensor device to a second state in which only non-sensitive data can be transmitted, and
change a state of the sensor device to the first state and deleting at least some of the stored sensitive data when a predefinable reset event occurs.

13. The sensor device according to claim 12, wherein the predefinable reset event includes: (i) a faulty and/or inadequate response of the second wireless communication interface to a connection signal of the first wireless communication interface, and/or (ii) a lack of confirmation of receipt of the second wireless communication interface, and/or (iii) an actuation event of an actuation element on the sensor device, and/or the object, and/or (iv) a predetermined sequence of sensor signals of the sensor device, and/or (v) a predetermined sequence of speed and/or rotation rate values of the sensor device, and/or (vi) a signal of a third wireless communication interface, and/or (vii) a reset message of the second wireless communication interface, and/or (viii) a lapse of a predetermined time since a change to the second state.

14. The sensor device according to claim 13, wherein all sensitive data are deleted when a reset event occurs.

15. The sensor device according to claim 12, wherein the sensor device includes an air pressure sensor configured to measure a tire pressure.

16. The sensor device according to claim 12, wherein the sensor device includes an acceleration sensor, and/or a speed sensor, and/or rotation rate sensor sensor.

17. The sensor device according to claim 16, wherein the sending of a connection signal is performed only when the acceleration sensor measures a centripetal force greater than 1.6 g, and/or when the rotation rate sensor measures a minimum rotation rate greater than 500°/s, and/or when the speed sensor measures a minimum speed greater than 10 km/h.

18. The sensor device ccording to claim 17, wherein the sending of the connection signal is only performed when the minimum rotation rate and/or the minimum speed is measured for at least 30 seconds.

19. The sensor device according to claim 12, wherein the first and/or the second wireless communication interface includes a Bluetooth Low Energy interface.

20. The sensor device according to claim 12, wherein the sending of the connection signal is based on: (i) an instantaneous angular velocity, or (ii) a wheel position, or (iii) a certain vehicle speed or acceleration, (iv) a direction of rotation of a wheel, (v) vehicle vibrations, (vi) a signal strength, or (vii) signal direction, or (viii) signal polarization.

21. A movable object, the moveable object being a vehicle, the moveable object comprising:
a second wireless communication interface configured to establish a connection to a first wireless communication interface of the sensor device, wherein the movable object is configured to:
operate the movable object in a first state in which only non-sensitive data can be transmitted to the first wireless communication interface,
receive a connection signal from the first wireless communication interface,
establish a secure connection to the sensor device using the first wireless communication interface,
transmit sensitive data such as connection data, including connection keys and parameter data, using the secure connection, and store the sensitive data;
transfer the movable object to a second state in which only non-sensitive data can be transmitted, and
change a state of the movable object to the first state and deleting at least some of the stored sensitive data, when a predefinable reset event occurs.

22. A system, comprising:
a sensor device including:
a first wireless communication interface for connection to a second wireless communication interface on a movable object, the moveable object being a vehicle, wherein the sensor device is configured to:
operate the sensor device in a first state in which only non-sensitive data can be transmitted to the second wireless communication interface,
send a connection signal to the second wireless communication interface when the sensor device s operated in a first state and is moved: at a predetermined speed and/or a predetermined rotation rate,
establish a secure connection to the moving object using the second wireless communication interface,
transmit sensitive data such as connection data, including connection keys and parameter data, using the secure connection, and store the sensitive data,
transfer the sensor device to a second state in which only non-sensitive data can be transmitted, and
change a state of the sensor device to the first state and deleting at least some of the stored sensitive data when a predefinable reset event occurs; and
a moving object, the moviding object being a vehicle, the moving object including:
a second wireless communication interface configured to establish the connection to the first wireless communication interface of the sensor device, wherein the movable object is configured to:
operate the movable object in a first state in which only non-sensitive data can be transmitted to the first wireless communication interface,
receive the connection signal from the first wireless communication interface,
establish the secure connection to the sensor device using the first wireless communication interface,
transmit the sensitive data such as connection data, including connection keys and parameter data, using the secure connection, and store the sensitive data;
transfer the movable object to a second state in which only non-sensitive data can be transmitted, and
change a state of the movable object to the first state and deleting at least some of the stored sensitive data, when a predefinable reset event occurs.
